(19) United States
(12) Patent Application Publication
(10) Pub. No.: US 2006/0218436 A1
(43) Pub. Date: Sep. 28, 2006

(54) System, method and software using a RAID device driver as backup for a RAID adapter

(75) Inventors: Jacob Cherian, Austin, TX (US); Rohit Chawla, Waco, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/090,612

(22) Filed: Mar. 25, 2005

(51) Int. Cl. G06F 11/00

(52) U.S. Cl. 714/6

(57) ABSTRACT

If a hardware-based RAID (redundant array of independent disks) engine fails, the system can use a driver-based RAID engine in place of the hardware-based RAID engine. Using the driver-based RAID engine may reduce system downtime, and provide redundancy for the RAID system without requiring extra hardware.

### TECHNICAL FIELD

This disclosure relates generally to redundant array of independent disks (RAID) drives, and more particularly to using a RAID device driver as a backup for a RAID adapter.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To provide the data storage demanded by many modern organizations, information technology managers and network administrators often turn to one or more forms of RAID (redundant arrays of inexpensive/independent disks), which may provide enhanced data reliability by distributing data across a logical grouping of disk drives rather than storing the data on a single disk drive. Distributing the data across multiple drives helps ensure that the failure of a single disk drive does not result in irretrievable data loss, since data on a failed drive can be reconstructed from data on the remaining drives.

A RAID engine, e.g. the portion of the RAID system that distributes data among the different disk drives, may be implemented either in software or hardware. Software implementations of RAID engines are sometimes referred to as “host-based,” and include RAID engines implemented by the operating system (OS-based) or by a disk-controller specific software driver (driver-based). RAID engines implemented in firmware or hardware (hardware-based) are generally implemented using storage adapters with a dedicated input/ouput processor (IOP-based) with or without a disk controller (IOC—IO Controller).

Some information handling systems use multiple RAID adapters to provide redundancy for the RAID engine. Two types of redundancy commonly used include active/active and active/passive. An active/active system uses multiple RAID adapters, with each adapter sharing part of the load during normal operations. In an active/passive system some adapters are designated as standby and remain idle. When an adapter fails a adapter designated as standby takes over this function. However, solutions that use multiple adapters introduce additional hardware to provide the protection, hence additional cost and complexity.

### SUMMARY

In accordance with teachings of the present disclosure, a system, method, and software are described for using a driver-based RAID (redundant array of independent disks) engine as a backup for a hardware-based RAID engine.

At least one embodiment provides a method that includes receiving an indication that a hardware-based RAID engine has malfunctioned, and implementing a driver-based RAID engine in response to receiving an indication of the malfunction. The hardware-based RAID engine may be implemented in a suitable RAID adapter, for example a RAID adapter implementing an input/output processor (IOP), while the driver-based RAID engine may be implemented using a software driver compatible with any of various operating systems.

Another embodiment provides an information handling system that includes a processor, memory, and an operating system (OS) that may be stored in the memory and executed by said processor. The information handling system also includes a storage adapter used to implement a hardware-based RAID engine, and a device driver, associated with said storage adapter. The device driver includes a program of executable instructions including at least one instruction to interface between said OS and said storage adapter, and at least one instruction to implement a driver-based RAID engine if the hardware-based RAID engine fails.

Yet another embodiment provides a computer readable medium tangibly embodying a program of executable instructions. The program of instructions includes at least one instruction to receive an indication that a malfunction is preventing a storage adapter from implementing a hardware-based RAID engine and at least one instruction to implement a driver-based RAID engine in response to receiving the indication of the malfunction.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagrams of a prior art system implementing an external redundant array of independent disks (RAID) configuration.

FIG. 2 is a block diagrams of a prior art system implementing an internal RAID configuration with redundant RAID adapters.

FIG. 3 is a block diagrams of a prior art system implementing an internal RAID configuration with a single RAID adapter.

FIG. 4 is a block diagram illustrating a prior art system employing a driver-based RAID engine.

FIG. 5 is a block diagram illustrating a prior art system employing a hardware based RAID engine.

FIG. 6 is a simplified block diagram of a prior art RAID controller.

FIG. 7 is a block diagram of a system including a driver-based RAID engine and a hardware-based RAID engine according to an embodiment of the present disclosure.

FIG. 8 is a flowchart illustrating a method according to an embodiment of the present disclosure.

### DETAILED DESCRIPTION

Preferred embodiments and their advantages are best understood by reference to FIGS. 1 through 8, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

An information handling system according to an embodiment of the present disclosure may employ any of various suitable types of redundant array of independent disks (RAID) drive configurations. Some commonly used prior art RAID configurations are illustrated in FIGS. 1-5. Most or all of these RAID configurations can be adapted for use with the teachings of the present disclosure.

The prior art system 100 illustrated in FIG. 1, for example, may include a host 110 that is not configured for use with RAID. Some such systems generally include one or more host bus adapters such as HBA 120 and HBA 130, which can be connected to an external RAID controller 140. External RAID controller 140 is, in turn, connected to enclosure 150, which includes one or more disk drives such as HDD 160.

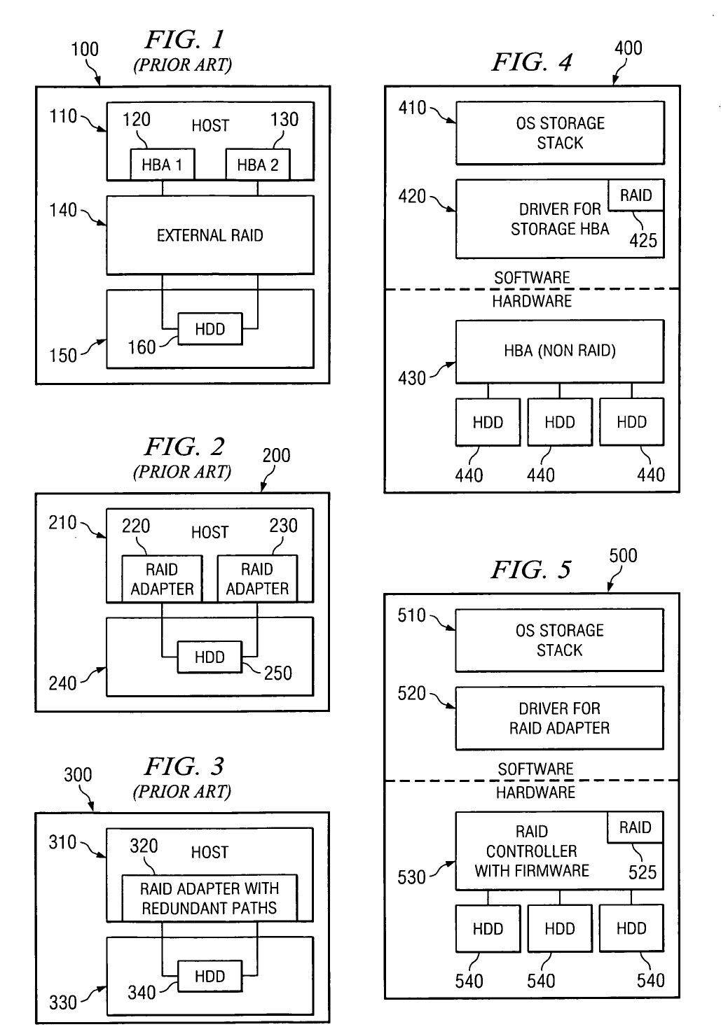

Alternatively, a system 200, as illustrated in FIG. 2, may include host 210 and enclosure 240. Host 210 may include one or more internal RAID adapters such as RAID adapters 220 and 230, so that an external RAID controller is unnecessary. Connecting two RAID adapters 220 and 230 to enclosure 240, which includes disk drives HDD 250, provides hardware redundancy for the RAID system.

FIG. 3 illustrates a system 300 which, unlike system 200, includes only a single RAID adapter. System 300 employs redundant paths between internal RAID adapter 320 and HDD 340 in enclosure 330 to provide some measure of failure tolerance.

Referring briefly to FIG. 4, a prior art system 400 employing a driver-based RAID engine 425 is illustrated. System 400 includes an operating system (OS) stack, such as stack 410 used to hold data or instructions bound for disk drives such as HDDs 440. Note that HDDs 440 are non-RAID devices. RAID engine 425 is included as part of the software driver 420, which is used as an interface between the OS and the non-RAID host bus adapter HBA 430. RAID engine 425 arranges the information to be stored in HDDs 440 so that HDDs 440 function similarly to actual RAID drives, although from the point of view of HBA 430 and HDDs 440, they are simply functioning in a normal, non-RAID manner.

Referring next to FIG. 5, a system that implements RAID functionality in hardware, e.g. system 500, is illustrated. Like system 400 (FIG. 4), system 500 includes HDDs 540, an OS storage stack 510, and a software driver 520. The RAID engine 525, however, is implemented in hardware, e.g. in the RAID controller 530, rather than in software driver 520.

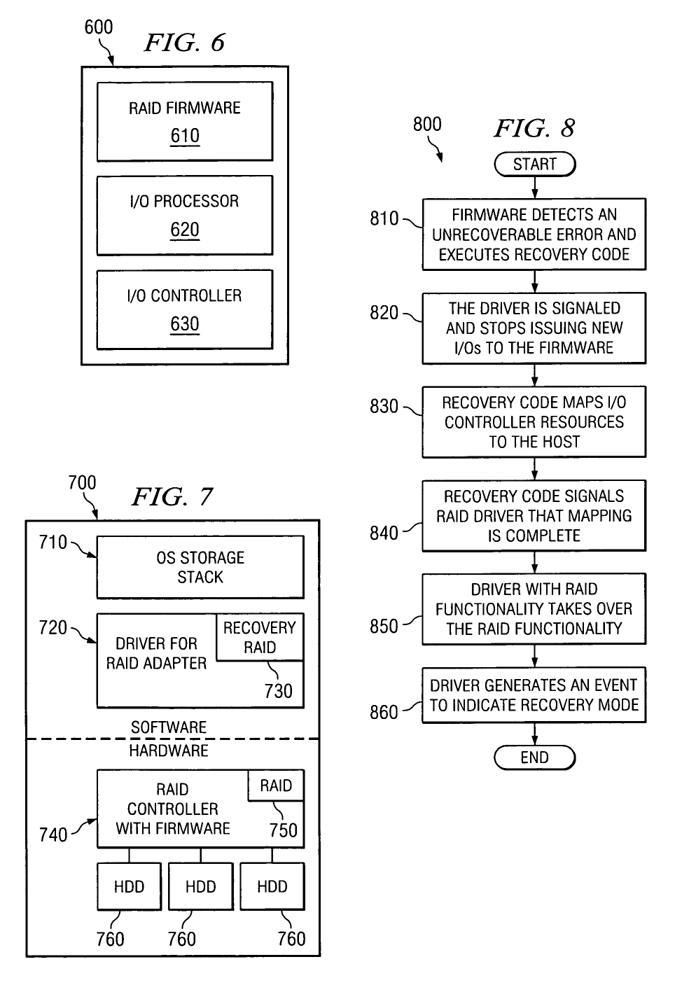

A RAID controller 600, suitable for use in system 500 is illustrated in FIG. 6. RAID controller 600 includes RAID firmware 610, an input/output processor (IOP) 620, and an input/output controller (IOC) 630. In the present preferred embodiment, IOP 620 is where RAID firmware 610 executes and IOP 620 further provides hardware support to implement RAID functionality. Also in the present embodiment, IOC 630 acts as the protocol engine and provides access to the associated disk drives over the storage protocol used. IOC 630 may be specific to one of many available storage protocols such as (but not limited to) Fibre Channel, SAS, SATA, ATA Parallel SCSI, etc..

In some implementations the IOP and IOC may not be separate components, but may be integrated into a single part. Note that the firmware 610 may be referred to as software used to control the operation of RAID controller 600. As used herein, however, since the firmware 610 is implemented in a RAID controller, firmware 610 is considered part of the hardware. Consequently, a RAID engine implemented in a controller's firmware is included in the meaning of the term “hardware-based RAID engine” and similar terms.

Referring now to FIG. 7, a system 700 will be discussed according to an embodiment of the present disclosure. System 700 includes software, e.g. OS storage stack 710 and RAID adapter driver 720, and hardware , e.g. RAID controller 740 and HDDs 760. In preferred embodiments RAID controller 740 is an internal RAID controller implemented as a peripheral component interconnect (PCI) card, a RAID-on-chip. An embodiment of RAID controller 740 includes and a hardware-based RAID engine such as RAID engine 750

According to at least one embodiment, RAID engine 750 is the primary RAID engine used by system 700 to implement RAID functionality. So, for example, when data or instructions in the OS storage stack 710 is to be written to HDDs 760, RAID adapter driver 720 provides the data or instructions to RAID controller 740, which implements the RAID functionality using hardware RAID engine 750. As noted earlier, hardware RAID engine may include firmware to implement or assist in implementing the desired RAID functionality.

As used herein, the term “RAID functionality” and similar terms may include, but is not limited to, calculating parity data and checksums as required to implement various RAID levels, determining on which disk various portions of information should be stored, and similar functions and managing cache, if present.

If hardware-based RAID engine 750 encounters an error that prevents it from properly implementing the desired RAID functionality, or if for some other reason it is desirable to stop using hardware-based RAID engine 750, a driver-based RAID engine such as recovery RAID engine 730 may be used to implement the desired RAID functionality. In this way, recovery RAID engine 730 can be used to provide backup RAID functionality for hardware RAID engine 750.

In some embodiments, the backup functionality provided by driver-based RAID engine 730 may not include the full set of functionality provided by hardware-based RAID engine 750. In other embodiments, however, driver-based RAID engine 730 provides the same or comparable RAID functionality as that provided by the hardware-based RAID engine. Note that while various embodiments designating a hardware based RAID engine as primary and a driver-based RAID engine as secondary are primarily discussed, herein, in other embodiments the roles may be reversed. That is to say, the driver-based RAID engine may be designated as primary and the hardware based RAID engine as secondary. Such embodiments may find application in legacy systems, where a more current driver-based RAID engine provides functionality not provided for by a hardware-based RAID engine, or in other suitable situations.

Referring next to FIG. 8, a method according to an embodiment of the present disclosure is presented. The method 800 begins at 810, where firmware included in a RAID adapter detects an unrecoverable error related to the RAID engine, and executes error recovery code. Examples of such unrecoverable errors include a corrupted flash image on the RAID adapter, multi-bit error correction code (ECC) errors, or the like.

The method proceeds to 820, where the device driver associated with the RAID adapter is directed to stop issuing input/output (I/O) commands, data, and/or instructions to the RAID adapter. Note that in some embodiments, directing the device driver to stop issuing I/Os involves simply notifying the device driver that the RAID adapter firmware has encountered an unrecoverable error, and letting the device driver implement its own failure recovery protocol.

The method proceeds from 820 to 830, where, in one embodiment, recovery code included in the RAID adapter maps IOC resources to the host information handling system, so that the device driver can access IOC resources directly, effectively bypassing the hardware RAID engine implemented in the RAID adapter's firmware.

At 840 the recovery code signals the device driver that IOC mapping is complete, and that the driver-based RAID engine included in the device driver can take over implementing the RAID functionality at 850.

In some embodiments, the driver-based RAID engine may provide reduced functionality compared to the hardware-based RAID engine. Additionally, the driver-based RAID engine may perform less efficiently than the hardware-based RAID engine. Thus, in at least one embodiment the device driver generates a recovery mode indication at 860 to inform the OS or other managing software application that the system is using the driver-based RAID engine instead of the hardware-based RAID engine. This indication may permit the OS to alter the way in which it performs disk stores or manages virtual memory to minimize the impact of any performance degradation.

It should be appreciated, however, that although a driver-based RAID engine may incur a performance penalty, use of the driver-based RAID engine as a backup can help to minimize system downtime without requiring the use of additional hardware resources. Additionally, the driver-based RAID engine provides a way to recover from a single point of failure not otherwise available.

It should also be appreciated that although the method of FIG. 8 has been described using particular actions performed in a particular order, other embodiments may use additional or fewer actions, or the actions may be performed in an order different than the illustrated order.

Although the disclosed embodiments have been described in detail, it should be understood that various changes, substitutions and alterations can be made to the embodiments without departing from their spirit and scope.

What is claimed is:

1. A method comprising:
receiving, at a device driver associated with a storage adapter implementing a hardware-based redundant array of independent disks (RAID) engine, an indication of a malfunction preventing the storage adapter from implementing the hardware-based RAID engine; and
implementing a driver-based RAID engine in response to receiving the indication of the malfunction.

2. The method of claim 1, further comprising using the storage adapter to provide the indication to the device driver.

3. The method of claim 1, wherein
the driver-based RAID engine has reduced functionality compared to the hardware-based RAID engine; and
further comprising providing an indication of the reduced functionality to a management application.

4. The method of claim 1, wherein the hardware-based RAID engine comprises an input/output processor (IOP) based RAID system.

5. The method of claim 4, wherein
the IOP-based RAID system includes an input/output controller (IOC); and
further comprising mapping IOC resources to enable the device driver to communicate with the IOC instead of the IOP.

6. The method of claim 1, wherein the hardware-based RAID engine comprises an input/output controller (IOC) based RAID system.

7. The method of claim 1, further comprising discontinuing command transmission to the hardware-based RAID engine in response to receiving the indication of the malfunction.

8. An information handling system comprising:
a processor;
memory operably coupled to said processor;
an operating system (OS) to be stored in said memory and executed by said processor;
a storage adapter operably coupled to implement a hardware-based RAID engine; and
a device driver associated with said storage adapter, said software driver comprising a program of executable instructions to be stored in said memory and executed by said processor, said program of instructions comprising:
at least one instruction executable to interface between said OS and said storage adapter; and
at least one instruction executable to implement a driver-based RAID engine

9. The information handling system of claim 8, wherein said at least one instruction executable to implement a driver-based RAID engine is executed in response to a failure of the hardware-based RAID engine.

10. The information handling system of claim 8, wherein said storage adapter comprises an input/output processor (IOP) to implement an IOP-based RAID engine.

11. The information handling system of claim 10, wherein said storage adapter comprises
an input/output controller (IOC); and
firmware configured to map IOC resources to enable the device driver to bypass the IOP and communicate directly with the IOC.

12. The information handling system of claim 11, wherein the firmware is further configured to provide an indication of a failure of the hardware-based RAID engine to the device driver.

13. The information handling system of claim 12, wherein said program of instructions further comprises at least one instruction to stop transmitting commands to the storage adapter in response to receiving the indication.

14. The information handling system of claim 8, wherein the storage adapter comprises an input/output controller (IOC) to implement an IOC-based RAID engine.

15. A computer readable medium tangibly embodying a program of executable instructions, said program of instructions comprising:
at least one instruction executable to receive an indication of a malfunction preventing the storage adapter from implementing the hardware-based RAID (redundant array of independent disks) engine; and
at least one instruction executable to implement a driver-based RAID engine in response to receiving the indication of the malfunction.

16. The computer readable medium of claim 15, wherein the hardware-based RAID engine comprises an input/output processor (IOP) based RAID system.

17. The computer readable medium of claim 16, wherein
the IOP-based RAID system includes an input/output controller (IOC); and
further comprising at least one instruction executable to bypass the IOP and communicate directly with the IOC.

18. The computer readable medium of claim 15, further comprising at least one instruction executable to stop transmitting commands to the hardware-based RAID engine in response to receiving the indication of the malfunction.

19. The computer readable medium of claim 15, further comprising at least one instruction to generate a notification indicating that the driver-based RAID engine is being used in place of the hardware-based RAID engine.

20. The computer readable medium of claim 15, wherein said program of instructions comprises a device driver associated with the storage adapter.
